(19) United States
(12) Patent Application Publication
(10) Pub. No.: US 2018/0374587 A1
(43) Pub. Date: Dec. 27, 2018

(54) Methods and Apparatus for Triggering Exothermic Reactions

(71) Applicant: IH IP Holdings Limited

(72) Inventors: Dennis G. Letts, Austin, TX (US); Joseph A. Murray, Raleigh, NC (US); Julie A. Morris, Flower Mound, TX (US); Tushar Tank, Raleigh, NC (US)

(21) Appl. No.: 15/781,274

(22) PCT Filed: Jan. 18, 2017
(86) PCT No.: PCT/US2017/013931

§ 371 Date: Jun. 4, 2018

Related U.S. Application Data
(60) Provisional application No. 62/263,121, filed on Dec. 4, 2015.

(51) Int. Cl. G21B 1/21; C01B 3/00; C01B 3/02; B01J 19/08

(52) U.S. Cl. CPC G21B 1/21; C01B 3/0026; C01B 3/02; B01J 2219/0852; B01J 2208/00646; B01J 2208/00716; B01J 2219/0809; B01J 19/087

(57) ABSTRACT

Methods and apparatus are disclosed for triggering and maintaining an exothermic reaction in a reaction material comprising a metal occluded with hydrogen. The reaction material is prepared by loading a hydrogen absorbing material, e.g., a transition metal, with a hydrogen gas that comprises one or more of hydrogen isotopes. Different conditions and system configurations for triggering the exothermic reaction are also disclosed.

### PRIORITY CLAIM

This application is a U.S. National Stage application of International Application No. PCT/US17/013931, filed on Jan. 18, 2017, which claims priority to U.S. Provisional Application No. 62/263,121, titled Methods and Apparatus for Triggering Exothermic Reactions, which was filed on Dec. 4, 2015, and the entire contents of which are hereby incorporated herein by reference.

### TECHNICAL FIELD

The present application relates generally to heat generation, and more specifically to triggering an exothermic reaction for excess heat generation.

### BACKGROUND

For decades, scientists have been searching for alternative energy sources to replace fossil fuels and nuclear power. Over the past thirty years, scientists have, on many occasions, observed the phenomenon of excess heat generation when hydrogen/deuterium has reached a high loading level in a variety of metals or alloys. This excess heat generation phenomenon has been attributed to exothermic reactions between occluded nuclei. In one theory that is based on the Heisenberg uncertainty principle, two deuterium nuclei, when trapped in the small confinement inside a metal lattice, have a wide spread of momentum. The combined probability of two deuterium nuclei having requisite momenta to overcome the Coulomb barrier may become statistically significant, triggering fusion reactions in the trapped deuterium gas. According to a second theory, the two trapped deuterium nuclei overcome the Coulomb barrier by tunneling through a quantum tunnel to reach a lower energy state, i.e., to form a ⁴He nucleus.

Although these experiments have been replicated around the world, efforts to generate excess heat in a metal or alloy loaded with hydrogen/deuterium in a consistent manner have not been successful. Scientists have explored different conditions in which generation of excess heat can be triggered at will and with control. However, research in the triggering conditions of exothermic reactions so far has been largely inconclusive.

The present application teaches advantageous methods and apparatus for triggering and maintaining exothermic reactions.

### SUMMARY

Methods and apparatus for triggering an exothermic reaction are disclosed.

In some embodiments, a device comprising a metal container and an electrode is used for triggering an exothermic reaction. The metal container is plated with a hydrogen absorbing material. The metal container has one or more open ends. The electrode is received through a first open end into the metal container. The metal container is filled with a pressurized hydrogen gas. To trigger an exothermic reaction, a voltage between the metal container and the electrode is applied. In some embodiments, the magnetic field may be optionally applied. The strength of the magnetic field is set above a pre-determined threshold. For example, the strength of the magnetic field may be between 500 and 700 Gauss. In some embodiments, the voltage applied between the metal container and the electrode is selected to be dependent on a dimension of the metal container. For example, the voltage may be dependent on the distance between the metal container and the electrode. In one embodiment, the hydrogen absorbing material plated on the interior wall of the metal container comprises nickel, palladium or other metals or metal alloys capable of forming a hydride or deuteride. In one embodiment, a layer of gold is plated underneath the hydrogen absorbing material. In another embodiment, a layer of silver or other metals that do not dissociate hydrogen or deuterium is plated underneath the hydrogen absorbing material.

In some embodiments, the device used for triggering an exothermic reaction comprises a metal container and an electrode. The electrode is received through an open end of the metal container. The electrode is plated with a hydrogen absorbing material. In some embodiments, the electrode is first plated with a layer of gold and the hydrogen absorbing material is plated on top of the layer of gold. The metal container may have one or more open ends and the open ends are sealed. The metal container is filled with a pressurized hydrogen gas. To trigger an exothermic reaction, a voltage between the metal container and the electrode is applied. The voltage is dependent on a dimension of the metal container, for example, the distance between the metal container and the electrode. Optionally, a magnetic field may be applied and the magnitude of the magnetic field is set above a pre-determined threshold.

In some embodiments, a device used for hosting an exothermic reaction comprises a metal container and an electrode, and preparation of the device for exothermic reactions comprises the following steps. The preparation starts with plating. In one embodiment, the metal container is plated with a hydrogen absorbing material. In another embodiment, the hydrogen absorbing material is plated on the electrode. After the plating, the electrode is inserted into the metal container and the metal container is sealed and filled with a pressurized hydrogen gas. An optional magnetic field of a pre-determined magnitude and a pre-specified voltage between the metal container and the electrode are applied to trigger an exothermic reaction.

### BRIEF DESCRIPTION OF FIGURES

FIG. 1 is a section view of an exemplary device for triggering an exothermic reaction.

FIG. 2 is a section view of a second exemplary device for triggering an exothermic reaction.

FIG. 3 illustrates an exemplary palladium lattice structure.

FIG. 4 is a functional block diagram illustrating an exemplary system configured to control an exothermic reaction.

FIG. 5 is a flowchart illustrating an exemplary process of preparing an exemplary exothermic device.

FIG. 6 is a graph illustrating the calorimetric measurements of an exothermic reaction occurring inside the exemplary devices described herein.

### DETAILED DESCRIPTION

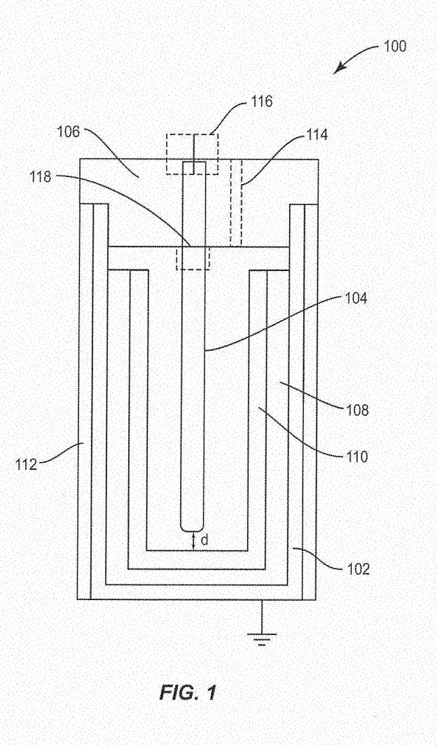

FIG. 1 illustrates an exemplary exothermic device 100 that comprises a metal container 102, an electrode 104, and a lid 106. The metal container 102 is made of a material that does not react with or absorb hydrogen. In one embodiment, the metal container 102 is made of stainless steel, for example, grade 316L. The wall of the metal container 102 should be thick enough to withstand plating, high pressure, high temperature, etc., the procedures and conditions that are part of the exemplary methods described herein. For instance, in one embodiment, the wall of the metal container 102 is thicker than 1/16 in. Other dimensions may work as well. In some embodiments, the metal container 102 is in the form of a tube and is of a cylindrical shape. The diameter of the cylinder may be between 0.8 and 1 in. For example, in one embodiment, the outer diameter of the cylinder is 1 inch and the inner diameter of the cylinder is 0.875 in. The length of the tube is approximately 12 in. The size of the tube determines how much hydrogen absorbing material can be plated inside the reactor. The amount of heat produced is proportional to the amount of hydrogen absorbing material plated inside the reactor. In some embodiments, the forms or shapes of the container are chosen for the convenience of manufacturing and ease of operation. For instance, the metal container 102 can be made of a rectangular shape.

The metal container 102 may have one or more open ends. In FIG. 1, the metal container 102 is shown to have only one open end. In some embodiments, the metal container 102 can have two or more open ends. At least one open end is required to be removable or changeable in order to accommodate the electrode 104, input/output ports 114, and voltage control device 116.

The electrode 104, as shown in FIG. 1, is received through one open end into the metal container 102. In some embodiments, the electrode 104 is placed in the center of the metal container 102, equidistant from the sidewalls of the metal container 102. The electrode 104 may be made of tungsten, molybdenum, cobalt, or nickel, or other rugged metal that can withstand high voltage and high temperature environments.

In some embodiments, the electrode 104 is made of the same shape as the metal container 102, to create a uniform electric field inside the metal container 102. In some embodiments, the electrode 104 is shaped as a rod with a diameter of 1/16 in. The metal container 102 is in the shape of a tube with an outer diameter of one inch and an inner diameter of 0.875 in. The length of the metal container 102 is 12 in and the electrode 104 extends into the metal container 102. The distance between the end of the electrode 104 and the bottom of the metal container 102 (d in FIG. 1) is preferably 0.6 in.

The voltage control device 116 is a removable electrical pass-through. The voltage control device 116 holds the electrode 104 in place at the center of the metal container 102. The voltage control device 116 is preferably made of ceramic, but can be of any electrically insulating material. The voltage control device 116 uses a safe high voltage connector to connect the electrode 104 to a high voltage power supply. A lid made of aluminum is placed over the electrical pass-through to provide accommodation for pressure controlling devices 114 configured for removing or supplying gas to the metal container 102 and for monitoring gas pressure inside the metal container 102. In another embodiment, the lid may be made of stainless steel or any other suitable metal.

To prepare the device 100 for exothermic reactions, the first step is to provide a hydrogen absorbing material for occluding hydrogen or deuterium. In a preferred embodiment, the hydrogen absorbing material 110 is plated either on the interior of the metal container 102 or on the electrode 104. Well known hydrogen absorbing materials include palladium, nickel, titanium, and other metals and alloys known to form hydrides or deuterides. In some embodiments, palladium, palladium alloy or a palladium product is used as the hydrogen absorbing material and is plated on the interior wall of the metal container via an electrolytic process. In one embodiment, the thickness of the plating is around 7 microns. On a macro scale, the thickness of the plating is uniform across the sidewalls and the bottom of the metal container 102. However, in a preferred embodiment, the surface of the plated hydrogen absorbing material is made rough on a micro scale, by performing the plating procedure under special conditions to force rough deposits.

In some embodiments, a layer of gold 108 is plated underneath the hydrogen absorbing material 110. In one embodiment, the thickness of the layer 108 is approximately 10 microns and is uniform across the sidewalls and the bottom of the metal container 102 on a macro scale. As with the hydrogen absorbing material 110, the layer of gold 108 is preferably rough, achieved during plating in the electrolysis process. The layer of gold 108 functions as a seal to maintain high hydrogen loading in the hydrogen absorbing material and may serve other functions as well, such as providing an interface between the container and the hydrogen absorbing material. Other metals, such as silver, which do not absorb hydrogen may be used to replace gold.

In some embodiments, when electrolysis is used as the plating method, the hydrogen absorbing material 110 and gold 108 are plated to cover the sidewalls and the bottom of the metal container 102 except a strip near the top of the metal container. This strip exposes the metal container to the high voltage differential applied between the metal container 102 and the electrode 104. To prevent sparking between the electrode 104 and the metal container 102 when a high voltage is applied, the portion of the electrode 104 that is parallel to the exposed area of the metal container is coated with an insulator 118, for example, Teflon.

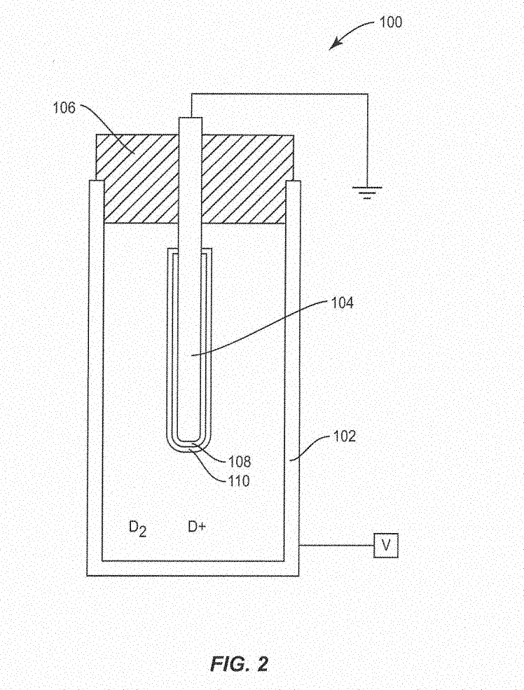

In the device 100 shown in FIG. 1, the hydrogen absorbing material 110 and the layer of gold 108 are plated on the interior walls of the metal container. In some embodiments, the hydrogen absorbing material can be plated on the electrode 104 as shown in FIG. 2. It is easier to plate the hydrogen absorbing material on the electrode 104 than inside the interior wall of the metal container. Additionally, the electrode 104 can be easily taken out and replaced with new test samples. In some embodiments, the electrode 104 is first plated with a non-hydrogen absorbing material 108, e.g., gold. The hydrogen absorbing material 110 is then plated on top of the non-hydrogen absorbing material 108. In FIG. 2, the electrode 104 is grounded. A power supply is connected to the metal container 102 to provide a voltage differential between the metal container 102 and the electrode 104. The voltage differential may be set at a pre-determined value. Experiments show that certain voltage values are optimal in triggering exothermic reactions and the optimal voltage values correlate to the geometry of the reactor 100.

Both FIG. 1 and FIG. 2 show that one of the electrodes is grounded. However it is noted that, in some embodiments, neither electrode may be grounded, i.e., the reactor can be made “floating.”

It is contemplated that resonant voltages exist inside the cylindrical metallic container described herein. The deuterium gas in the container is ionic and can be accelerated by the electric field produced by high voltage. The velocity achieved by the deuterium ions is determined by the mean free path of the deuterium ions. The deuterium ion velocity in turn determines the magnitude of the Debroglie pilot wave associated with the deuterium ion, which determines the size of the confinement space into which the deuterium ions can fit. In a metal hydride, there may be several relevant confinement dimensions. For example, the average separation distance between two deuterium atoms in a deuterium gas molecule in free space is 0.741 Angstroms. The average separation distance for D2 molecular ions is 1.058 Angstroms. The lattice dimension for deuterated palladium in the beta phase is 4.026 Angstroms and the size of a palladium vacancy is conjectured to be one half of the lattice dimension, or 2.013 Angstroms. There is experimental evidence suggesting that D-D exothermic reactions are possible in the vacancies of certain metal deuterides, most notably palladium. It has been experimentally observed that exothermic reactions are triggered in palladium deuterides when the voltage, temperature, and pressure are set to accelerate deuterium ion to achieve a Debroglie wavelength of 2.013 Angstroms, which is numerically equal to the conjectured size of a palladium lattice vacancy, as shown below. The equation below, Eq. (1), provides the relationship between the voltage V₀ and the Debroglie wavelength X under a given pressure P and temperature T.

$${V}_{0} = \frac{{h}^{2}}{2} ⌊ ln \frac{b}{a} \cdot \frac{r \sqrt{2} π {d}^{2} {N}_{A}}{qRT} \cdot \frac{P}{{M}_{D} {X}^{2}} ⌋ , \qquad Eq . ( 1 )$$

### Where:

h=Planck's constant=6.626×10⁻³⁴ J·s
b=inside radius of metal cylindrical container=0.0111 m
a=radius of central electrode =0.0007938m
r=b
d=cross sectional dimension of deuterium=2.75 Angstroms
N_{A} Avogadro's constant=6.022×10²³ mol⁻¹
q=elementary charge=1.602×10⁻¹⁹C
R=molar gas constant=8.314 J/mol K
T=gas temperature in Kelvin; for this example, T=62C
P=gas pressure in Pascal's=1.05 psi
M_{D}=deuterium mass=3.343×10⁻²⁷ kg
X=confinement dimension=Debroglie wavelength
The following table lists the Debroglie wavelength of a deuterium ion for different average pressures, temperatures, and voltages:

| Avg. psi | Avg. voltage | T centigrade | Debroglie (A) |
|---|---|---|---|
| 1.10 | 1237 | 54.3 | 0.740 |
| 1.16 | 176 | 54.3 | 2.013 |

In some embodiments, an exothermic response was observed when the Debroglie wavelength of the deuterium ions was approximately 0.741 A and 2.013 Angstroms. These wavelengths correspond to the distance between two deuterium atoms in molecular deuterium and the conjectured size of a palladium vacancy respectively.

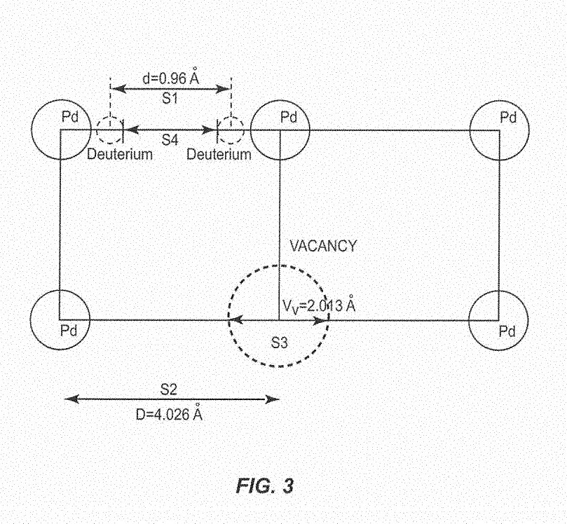

In an exemplary palladium lattice shown in FIG. 3, a deuteron, i.e., a deuterium atom or ion, can be trapped in different locations within the lattice; for example, the deuterium ion can be trapped in the open space between palladium atoms (shown as S1 in FIG. 3). Deuterium ions can also be trapped in a palladium vacancy shown as S3 where a palladium atom is missing in the lattice. The diameter of the vacancy is assumed to be one half of the length of the lattice parameter, or 2.013 Angstroms. To fit inside the vacancy, a deuteron is required to have a Debroglie wavelength equal to or smaller than 2.013 Angstrom. Further, to allow two deuterons to bond to form molecular deuterium in the vacancy, the deuterium ions would need to have a Debroglie wavelength approximately equal to S4, which is approximately 0.741 Angstroms.

In some experiments, an exothermic reaction was observed experimentally when the deuterons were accelerated with 1,237 volts and on a separate occasion with 176 volts. The experimental conditions at that time were such that Debroglie wavelengths of 2.014 Angstroms and 0.74 Angstroms were produced as the deuterons accelerated toward the reactor wall and into the palladium. This suggests that there may be a connection between the deuterium ion's Debroglie wavelength and one or more physical lattice dimensions where the ions may be trapped. To accelerate the deuterons to achieve a Debroglie wavelength that corresponds to the dimensions of the physical lattice the ions may be trapped in, the voltage V₀ applied between the metal container 102 and the electrode 104 can be determined using Eq. (1).

To summarize, a palladium lattice provides at least two locations where deuterium ions can be trapped, providing an opportunity for the wave functions of two deuterium ions to overlap: in the open space between palladium atoms, or in a vacancy in the palladium lattice as shown in FIG. 3. The open space between palladium atoms on average has a dimension of 0.96 Angstroms, while the vacancy has a conjectured dimension of 2.013 Angstroms. Pressure, temperature, and voltage conditions can be varied to produce a wide range of Debroglie wavelengths that match the required physical dimensions.

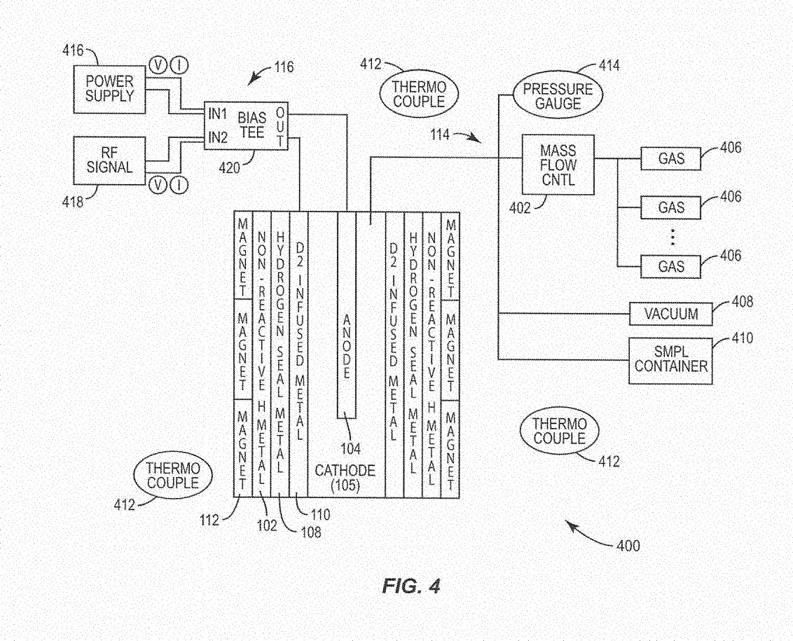

In some embodiments, the open ends of the reactor 100 are sealed to achieve and maintain different pressures needed at different operational stages. In some embodiments, the reactor 100 can have two open ends and the two open ends can be configured to receive separately the electrode 104 and the pressure and voltage controlling devices, 114 and 116. In some embodiments, one open end may be permanently sealed via welding, orbital welding, for example, to avoid chemical reactions. The open end or ends that receive the electrode 104 and the pressure and voltage controlling devices, 114 and 116, require non-permanent sealing, as described above. The pressure controlling devices 114 and the voltage controlling device 116 include an array of control devices shown in FIG. 4.

FIG. 4 is a block diagram illustrating an exemplary system 400 for controlling an exothermic reaction in a hydrogen-infused or hydrogen-occluded metal. The exemplary system 400 comprises a cathode 105, an anode 104, pressure controlling devices 114, a voltage-controlling device 116, magnets 112 (optional) and a plurality of thermocouples 412. The anode 104 is connected to a power supply via the voltage-controlling device 116. The cathode 105 is made of a metal that serves as a metal container 102. The metal container 102 does not react with hydrogen. The metal container is plated with a metal 108 that is non-absorbent of hydrogen gas. A layer of hydrogen/deuterium occluded metal 110 is plated on top of the metal 108 and the metal 108 functions as a seal to prevent loss of the hydrogen/deuterium infused in the metal 110. Certain types of metals, for example, palladium, nickel, titanium, and lanthanum, are known to be hydrogen absorbing and have the capacity to absorb a large quantity of hydrogen. Although in FIG. 4, the anode 104 is connected to the power supply and the cathode 105 is grounded, as discussed above, the positions of the cathode 105 and the anode 104 are switched if the metal 108 and the hydrogen/deuterium occluded metal 110 are plated on the anode 104. Also, it is noted that herein in this disclosure, term “metal” may refer to a single metal, a metal alloy, or otherwise any metal product.

In FIG. 4, external magnets are installed on the outside of the reactor cylinder to provide a magnetic field inside the reactor wall where the deuterium ions enter the palladium or other deuterium absorbing material. Experiments have shown that an external magnetic field may be used to control the rate of the exothermic reactions observed. In some embodiments, experiments have been performed without external magnets but the earth's magnetic field of 0.5 gauss may provide sufficient field strength so exothermic reactions can be triggered and maintained. It has been observed experimentally that reactor power output is directly proportional to magnetic field strength. A Helmholtz coil (not shown) can be used to cancel or control the magnitude of the magnetic field impinging upon the reactor.

The exemplary system 400 includes a plurality of thermocouples 412, which are placed in various positions inside the system 400 for calorimetric measurements. The exemplary system 400 also includes the voltage controlling device 116 and the pressure controlling devices 114. The voltage-controlling device 116 further includes a connector (not shown), a power supply 416, and an optional RF signal generator 418. In some embodiments, the voltage applied to the anode 104 includes only a DC component that is approximately 5000 volts with a 5 mA current. In some embodiments, the voltage applied to the anode 104 includes both a DC component and an RF component that are combined in the voltage control device 116. An example of a voltage combining component is a Bias Tee 420, which overlays the RF signal onto the DC offset without amplifying either signal. The pressure controlling devices 114 also include a pressure gauge 414 for measuring the pressure inside the system 400, a mass flow control 402 for controlling the quantity of input gas, and a number of gas canisters 406.

In preparing the system 400 for an exothermic reaction in the hydrogen occluded metal 110 that is plated on the cathode 105, the reactor chamber (i.e., the sealed space between the anode 104 and the cathode 105) is pumped down to a high vacuum of pressure, e.g., 10⁻⁶ Torr, by connecting the system to a vacuum chamber (not shown). After the reactor chamber has been cleared of unwanted gas residuals, different types of reaction gases, each stored in a gas container 406, can be introduced into the reactor chamber via the mass flow controller 402 for exothermic reactions. The reaction gas may include deuterium gas, hydrogen gas, or a mixture of hydrogen and deuterium gases. Once the reaction gas in the reaction chamber reaches a desired pressure set point, a valve is closed to seal the chamber. To trigger an exothermic reaction in the hydrogen infused metal, a triggering condition is applied.

In some embodiments, the triggering condition includes applying a voltage differential between the cathode 105 and the anode 104. The voltage differential may be set to a resonant RF voltage as described above. The resonant voltage is dependent on a geometric dimension or dimensions of the reaction chamber. In some embodiments, the power supply used to provide the resonant voltage may include a DC component only. In some embodiments, the power supply may include both a DC component and an RF signal.

In some embodiments, the triggering condition further includes applying a magnetic field in the reaction chamber. The magnitude of the magnetic field is preferably set to be above a pre-determined threshold. The magnetic field may be supplied through the magnets 112 or through currents using Helmholtz coils (not shown). The magnetic field can also be a component of the earth's magnetic field.

In some experiments, following the triggering of an exothermic reaction, a sample of gas may be extracted from the reaction chamber via the pressure controlling devices 114, and stored in a sample chamber 410. The sample may then be analyzed, using e.g., mass spectroscopy, to ascertain chemical or physical changes that may reveal details of the reaction. For example, the presence of helium may indicate a nuclear fusion reaction of hydrogen nuclei.

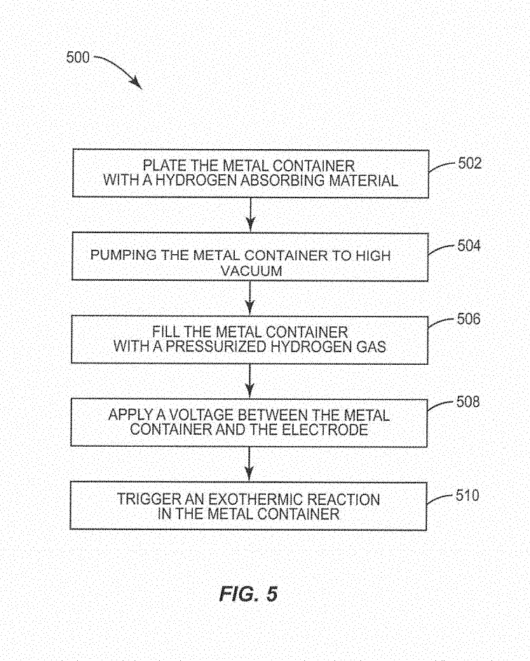

FIG. 5 is a flow chart illustrating an exemplary process for preparing and triggering an exothermic reaction in the exemplary system 400. The system 400 comprises a metal container (e.g., the metal container 102) and an electrode (e.g., the anode 104). In preparing the system 400, the metal container is plated with a hydrogen absorbing material (e.g., the hydrogen/deuterium occluded metal 110) (step 502) and an electrode is inserted into the metal container. The metal container is then pumped to high vacuum (step 504) and filled with a pressurized hydrogen gas (step 506). In some embodiments, the pressure of the pressurized hydrogen gas ranges from 0.01 PSIA to 2 PSIA. A pre-determined voltage is applied between the metal container and the electrode (step 508). The pre-determined voltage is dependent on one or more geometric dimensions of the metal container and the electrode, and may be set to one of the resonant RF voltages described above. The value of the voltage is determined to trigger an exothermic reaction in the metal container (step 510). With a proper ambient temperature and a maintained hydrogen/deuterium gas pressure, the exothermic reaction can be sustained in the metal container.

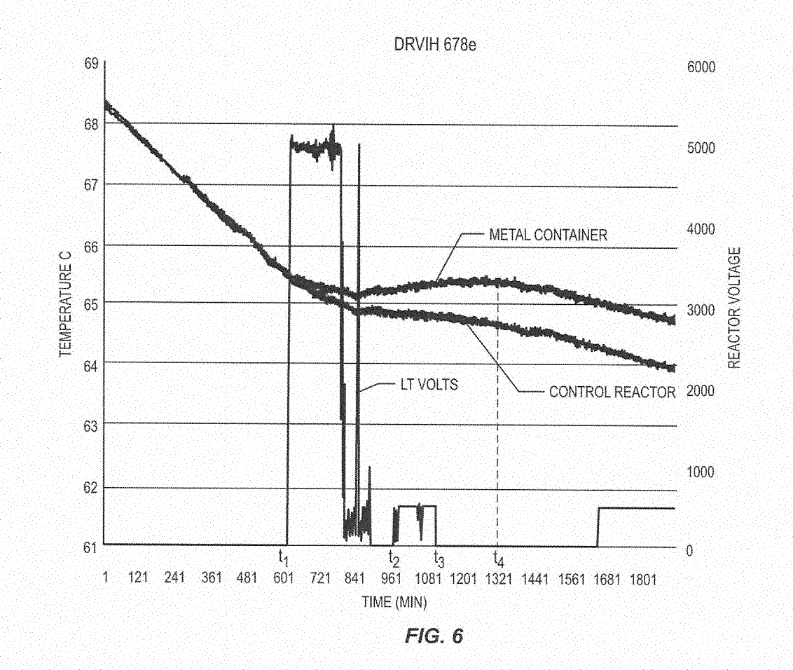

FIG. 6 is a graph illustrating the results of an exothermic reaction. To facilitate calorimetric measurements, the metal container 102 is immersed into a heat sink that collects the excess heat generated during the exothermic reaction. In one embodiment, the heat sink is a water tank. The temperatures at various locations of the heat sink are monitored and the changes in the temperatures are recorded. The amount of heat emitted by the metal container 102 and collected by the heat sink can be determined based on the temperature changes and the specific heat of the heat sink. Based on the calorimetric measurements performed in the heat sink, the temperature of the metal container 102 can be determined. The temperature of the metal container 102 is monitored and recorded throughout the exothermic reaction. The recorded temperature of the metal container 102 is plotted against time in FIG. 6. The temperature scale is shown on the left-hand side of the graph. As a comparison, the temperature of a control reactor is also recorded and plotted in FIG. 6. The control reactor has the same configuration as the metal container 102 except that it contains no pressurized hydrogen/deuterium gas. FIG. 6 further illustrates the voltage applied between the metal container 102 and the electrode 104, with the voltage scale shown on the right-hand side of the graph. The same voltage is also applied in the control reactor for the purpose of comparison study.

The experiment runs for about three and half days. At the beginning, the temperatures of the metal container 102 and the control reactor coincide. At time t1, a power source supplying a voltage of approximately 5,000V and a current of 0.0001 amperes is turned on for about 4 hours. From time t1, the temperature of the metal container 102 and that of the control reactor start to diverge. Between time t1 and time t4, the difference between the two temperatures increases with time despite the fact that no significant voltage is applied during this time period, except for a short time period between t2 and t3. During the time period between t2 and t3, a relatively small voltage was applied. More notable is the apparent increase in the temperature of the metal container 102 during the time period between t3 and t4 as there is no apparent input of power from the high voltage stimulation. During the remainder time of the experiment, the temperature of the metal container 102 remains several Celsius degrees higher than that of the control reactor.

The invention disclosed herein may be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A device for triggering and maintaining an exothermic reaction, comprising:
a metal container plated with a hydrogen absorbing material, said metal container having one or more open ends and filled with a pressurized hydrogen gas;
an electrode received through a first open end into the metal container; and
a power supply system configured to apply a first voltage between the metal container and the electrode, said first voltage being dependent on a dimension of the metal container and configured to trigger the exothermic reaction.

2. The device of claim 1, wherein the pressurized hydrogen gas comprises deuterium.

3. The device of claim 1, wherein the hydrogen absorbing material comprises one or more of group 10 elements.

4. The device of claim 1, wherein a second voltage is applied to maintain the exothermic reaction and wherein the second voltage is lower than the first voltage.

5. The device of claim 1, wherein a layer of gold is plated underneath the hydrogen absorbing material.

6. The device of claim 1, wherein a layer of silver is plated underneath the hydrogen absorbing material.

7. The device of claim 1, wherein the first voltage applied between said metal container and said electrode is dependent on a distance between said metal container and said electrode.

8. The device of claim 7, wherein the distance between said metal container and said electrode is 0.4375 inch and the first voltage is approximately 5000V.

9. The device of claim 1, wherein the pressure of the pressurized hydrogen gas is between 0.01PSIA-2 PSIA.

10. The device of claim 1, wherein the metal container is made of stainless steel and the one or more open ends are sealed to maintain a pre-determined pressure.

11. The device of claim 1, wherein a magnetic field of a pre-determined magnitude is applied.

12. A device comprising:
a metal container, said metal container having one or more open ends and filled with a pressurized hydrogen gas;
an electrode received through a first open end into the metal container, said electrode plated with a hydrogen absorbing material; and
a power supply system configured to supply a first voltage between the metal container and the electrode, said first voltage being dependent on a dimension of the metal container.

13. The device of claim 12, wherein the pressurized hydrogen gas comprises deuterium.

14. The device of claim 12, wherein a layer of gold is plated beneath the hydrogen absorbing material.

15. The device of claim 12, wherein the pressure of the pressurized hydrogen gas is 0.01PSIA-2 PSIA.

16. The device of claim 12, wherein the first voltage applied between said metal container and said electrode is dependent on a distance between said metal container and said electrode.

17. The device of claim 16, wherein the distance between said metal container and said electrode is 0.4375 inch and the first voltage is approximately 5000V.

18. A method of preparing an exothermic device for heat generation, the exothermic device comprising a metal container and an electrode, said method comprising:
plating the metal container with a hydrogen absorbing material;
pumping the metal container to high vacuum;
filling the metal container with a pressurized hydrogen gas;
applying a voltage between the metal container and the electrode, said voltage configured to be dependent on a dimension of the metal container; and
triggering an exothermic reaction in the metal container.

19. The method of claim 18, wherein the dimension of the metal container is a distance between the metal container and the electrode, and wherein the voltage is configured to be dependent on a dimension of the metal container so as to trigger the exothermic reaction in the metal container.

20. A method of preparing an exothermic device for heat generation, the exothermic device comprising a metal container and an electrode, said method comprising:
plating the electrode with a hydrogen absorbing material;
pumping the metal container to high vacuum;
filling the metal container with a pressurized hydrogen gas;
applying a voltage between the metal container and the electrode, said voltage dependent on a dimension of the metal container; and
triggering an exothermic reaction in the metal container.
